(19) United States
(12) Patent Application Publication
(10) Pub. No.: US 2021/0117874 A1
(43) Pub. Date: Apr. 22, 2021

(54) SYSTEM FOR DISPATCHING A DRIVER

(71) Applicant: Lyft, Inc., San Francisco, CA (US)

(72) Inventors: Chris Lambert, San Francisco, CA (US); Christopher Sholley, San Bruno, CA (US); Grayson McClure Badgley, San Francisco, CA (US)

(21) Appl. No.: 17/031,252

(22) Filed: Sep. 24, 2020

Related U.S. Application Data
(63) Continuation of application No. 13/828,952, filed on Mar. 14, 2013, now abandoned.

(51) Int. Cl. G06Q 10/02

(52) U.S. Cl. CPC G06Q 10/02

(57) ABSTRACT

A system for dispatching a driver comprises an interface and a processor. The interface is configured to receive a ride request from a rider located at a start location. The processor is configured to determine a selected driver to offer the ride request to. The system inefficiency score is reduced in the event that the selected driver accepts the request. The system inefficiency score comprises a sum over a set of drivers of an estimated time until a next passenger is picked up.

### CROSS-REFERENCE TO RELATED APPLICATIONS

The present application is a continuation of U.S. application Ser. No. 13/828,952, filed on Mar. 14, 2013. The aforementioned application is hereby incorporated by reference in its entirety.

### BACKGROUND OF THE INVENTION

Mobile device technology enables people to communicate from any location. However, people still need to move between locations. Even though there are many people driving and there are many people who wish to go to a different location from where they are, the people who wish to go are not typically driven by the many people driving.

### BRIEF DESCRIPTION OF THE DRAWINGS

Various embodiments of the invention are disclosed in the following detailed description and the accompanying drawings.

FIG. 1 is a block diagram illustrating an embodiment of a system for connecting a driver and a rider.

FIG. 2 is a block diagram illustrating an embodiment of a lift management system.

FIG. 3 is a block diagram illustrating an embodiment of a user system.

FIG. 4 is a diagram illustrating an embodiment of a city map showing drivers for a lift management system.

FIG. 5 is a diagram illustrating an embodiment of a city map showing drivers and regions available to them.

FIG. 6 is a diagram illustrating an embodiment of a city map showing a set of regions and expected ride request wait times.

FIG. 7 is a diagram illustrating an embodiment of a driver inefficiency calculation.

FIG. 8A is a flow diagram illustrating an embodiment of a process for estimating driver inefficiency.

FIG. 8B is a flow diagram illustrating an embodiment of a process for calculating a system inefficiency score.

FIG. 9 is a flow diagram illustrating an embodiment of a process for dispatching a driver.

FIG. 10 is a flow diagram illustrating an embodiment of a process for determining an estimate of a time until a ride request.

FIG. 11 is a flow diagram illustrating an embodiment of a process for dispatching a driver.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for dispatching a driver comprises an interface configured to receive a ride request from a rider located at a start location, and a processor configured to determine a selected driver to offer the ride request to, wherein a system inefficiency score is reduced in the event that the selected driver accepts the request, and wherein the system inefficiency score comprises the sum over a set of drivers of the estimated time until the next passenger is picked up. The system for dispatching a driver additionally comprises a memory coupled to the processor and configured to provide the processor with instructions.

In some embodiments, when a potential rider places a ride request to a system for connecting a driver and a rider, the system selects a driver and delivers the ride request to the selected driver. The driver either accepts the ride request and begins driving to meet the rider; or ignores the ride request. If the driver ignores the ride request, a next driver is selected, and the process is repeated until a driver accepts the request or there are no more drivers to deliver the request to. A system for dispatching a driver comprises a system for determining an ordering of drivers to deliver the request to in order to maximize system efficiency, i.e., to maximize the total fraction of drivers carrying passengers over the course of a day.

In some embodiments, in order to maximize system efficiency, the system for dispatching a driver maintains a system inefficiency score, quantifying the inherent system inefficiency at any point in time. The inefficiency score for a given driver comprises an estimate of the time until that driver is carrying a passenger, i.e., the sum of the estimated time until that driver receives and accepts a driver request and the estimated time for the driver to drive to the location of the request. The inefficiency score for a given driver additionally describes a time to beat for a drive time to a given request—for example, if the inefficiency score for a driver is 12 minutes (estimating that the driver will have a passenger in his car in 12 minutes), and the driver receives a ride request 20 minutes away, it will reduce the driver efficiency to accept the request. The system inefficiency score comprises the sum of the driver inefficiency scores for all active drivers. Since the inefficiency score for a driver estimates the time until a driver is carrying a passenger, drivers who are already carrying passengers automatically have an inefficiency score of zero minutes. The system inefficiency score thus comprises the sum of the driver inefficiency scores for all drivers without passengers.

When the system for dispatching a driver receives a driver request, it recalculates the system inefficiency score once for each available driver, under the assumption that the driver request has been given to that driver. The available drivers are then ranked according to their associated system inefficiency scores, from lowest to highest. The available driver with the lowest associated system inefficiency score is delivered the request. If the driver does not accept the request, the request is then delivered to the driver with the second lowest system inefficiency score, and so on.

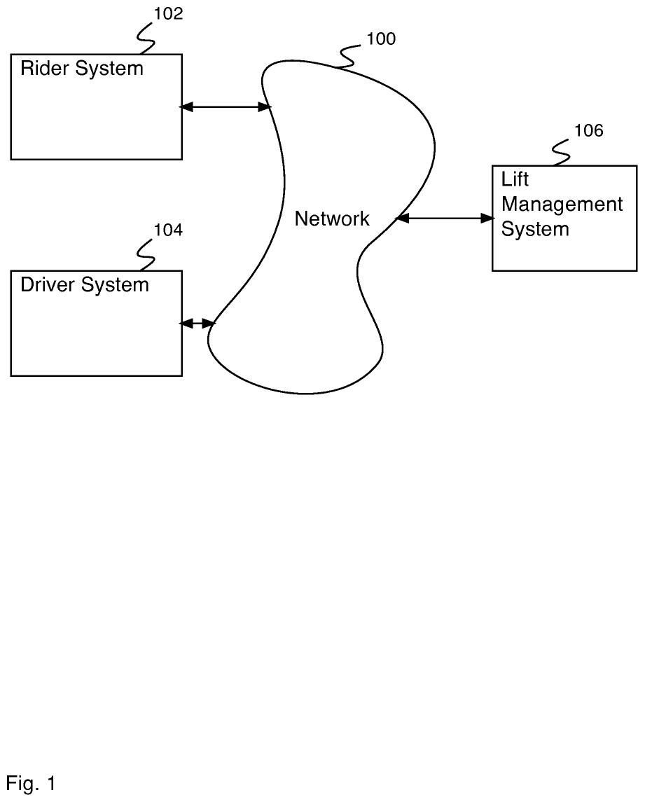

FIG. 1 is a block diagram illustrating an embodiment of a system for connecting a driver and a rider. In the example shown, FIG. 1 comprises network 100. In various embodiments, network 100 comprises one or more of the following: a local area network, a wide area network, a wired network, a wireless network, the Internet, an intranet, a storage area network, a cellular network, or any other appropriate communication network. In the example shown, rider system 102 and driver system 104 comprise user systems (e.g., computing systems for operation by users). In some embodiments, one or more of rider system 102 and driver system 104 comprises a system accessed by a user directly (e.g., the user is in proximity with the user system). In some embodiments, one or more of user system 102 and user system 104 comprises a system accessed by a user remotely (e.g., the user is not in proximity with the user system, and accesses the user system via network 100 and a separate user system). In the example shown, rider system 102 and driver system 104 comprise mobile devices (e.g., smartphones, tablet computers, etc.). Rider system 102 and driver system 104 comprise systems accessing lift management system 106 (e.g., accessing lift management system 106 via network 100). In various embodiments, there are 2, 5, 22, 122, 4320, 26100, or any other appropriate number of user systems (e.g., rider systems and driver systems) accessing lift management system 106. Lift management system 106 comprises a system for managing drivers giving riders lifts. In some embodiments, lift management system 106 comprises a system for connecting a rider and a driver. In some embodiments, lift management system 106 comprises a system for managing rider donations. In some embodiments, lift management system 106 comprises a system for dispatching drivers. In various embodiments, lift management system 106 comprises a computer, a computer with multiple processors, multiple computers connected via a local network, multiple computers connected via a wide area network, multiple computers connected via the Internet, multiple computers connected via network 100, or any other appropriate computing system or systems. In various embodiments, the processors comprising rider system 102, driver system 104, and lift management system 106 comprise any one of a variety of proprietary or commercially available single or multi-processor systems (e.g., an Intel™-based processor) or other type of commercially available processor able to support communications in accordance with each particular embodiment and application.

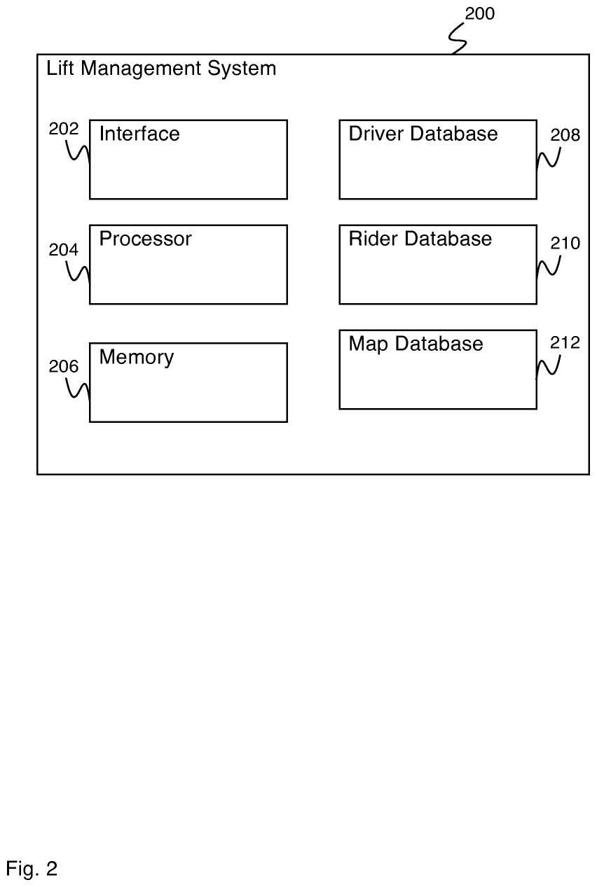

FIG. 2 is a block diagram illustrating an embodiment of a lift management system. In some embodiments, lift management system 200 comprises lift management system 106 of FIG. 1. In the example shown, lift management system 200 comprises interface 202. In various embodiments, interface 202 comprises an interface for receiving ride requests, sending rider notifications, receiving rider accept and deny indications, sending connect notifications, receiving location information, sending and receiving ride start notifications, sending and receiving ride complete notifications, sending and receiving donation information, sending and receiving driver rating information, sending and receiving rider rating information, sending donation summary information, or sending or receiving any other appropriate information. In some embodiments, interface 202 communicates with a user system (e.g., a driver mobile device or a rider mobile device) via a network. Processor 204 comprises a processor for receiving and processing information. In some embodiments, processor 204 communicates with interface 202. Processor 204 receives information from interface 202 and determines what information should be sent by interface 202. In some embodiments, processor 204 determines whether a driver accepts a request from a rider. Memory 206 comprises a memory coupled to processor 204 and configured to provide processor 204 with instructions. Driver database 208 comprises driver information (e.g., driver names, driver schedules, driver histories, driver ratings, driver donation amounts, driver images, driver car images, etc.) Rider database comprises rider information (e.g., rider names, rider histories, rider ratings, rider donation amounts, rider images, etc.). Map database 212 comprises map information. In some embodiments, processor 204 uses map information from map database 212 to plan routes.

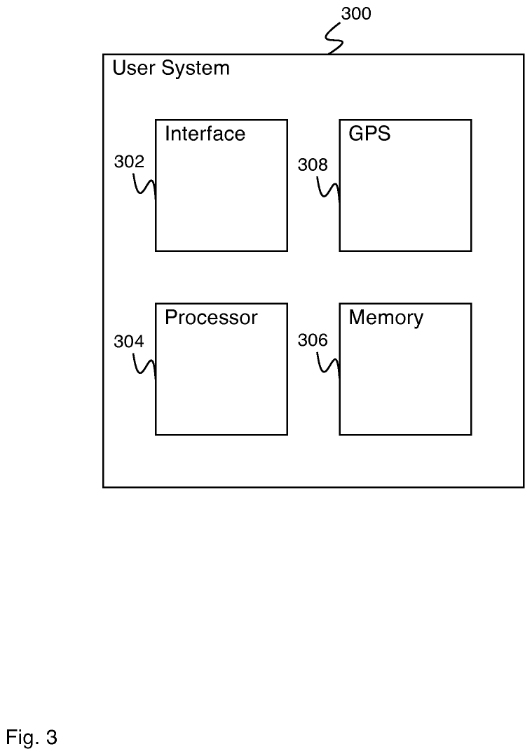

FIG. 3 is a block diagram illustrating an embodiment of a user system. In some embodiments, user system 300 of FIG. 3 comprises rider system 102 of FIG. 1. In some embodiments, user system 300 of FIG. 3 comprises driver system 104 of FIG. 1. In the example shown, user system 300 comprises interface 302. In various embodiments, interface 302 comprises an interface for sending ride requests, receiving rider notifications, sending rider accept and deny indications, receiving connect notifications, sending location information, sending and receiving ride start notifications, sending and receiving ride complete notifications, sending and receiving donation information, sending and receiving driver rating information, sending and receiving rider rating information, receiving donation summary information, or sending or receiving any other appropriate information. Processor 304 receives information from interface 302 and determines what information should be sent by interface 302. Memory 306 comprises a memory coupled to processor 304 and configured to provide processor 304 with instructions. GPS (e.g., global positioning system) 308 comprises a GPS for determining a user system position. In some embodiments, GPS position information is transmitted by interface 302 to a lift management system.

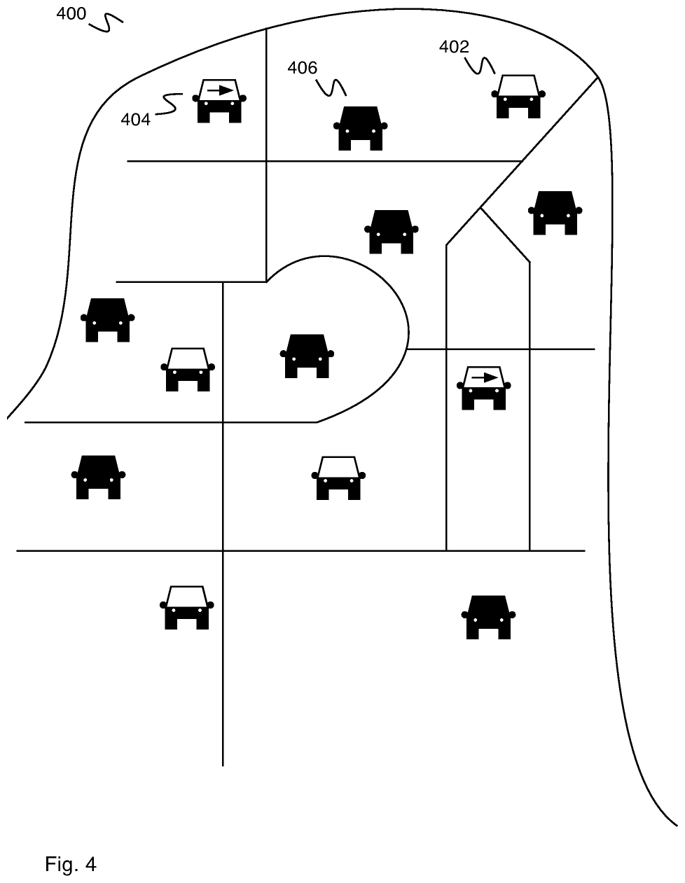

FIG. 4 is a diagram illustrating an embodiment of a city map showing drivers for a lift management system. City map 400 comprises a city map showing city streets and the current location of each driver for the lift management system. In the example shown, car icons drawn with open windshields (e.g., car icon 402) comprise drivers that do not currently have passengers and are waiting for requests. Car icons drawn with arrows (e.g., car icon 404) comprise drivers that have accepted a ride request but have not yet picked up the rider (e.g., drivers that are in the process of driving to the rider). Car icons drawn with black windshields (e.g., car icon 406) comprise drivers that have passengers and are taking the passengers to their destinations. When computing a system inefficiency score for the system shown in FIG. 4, drivers that do not currently have passengers contribute the estimated time until a request is received plus the estimated time to get to the request, drivers that have accepted a ride request but have not yet picked up the rider contribute the estimated time until the rider is picked up, and drivers that have passengers contribute zero time.

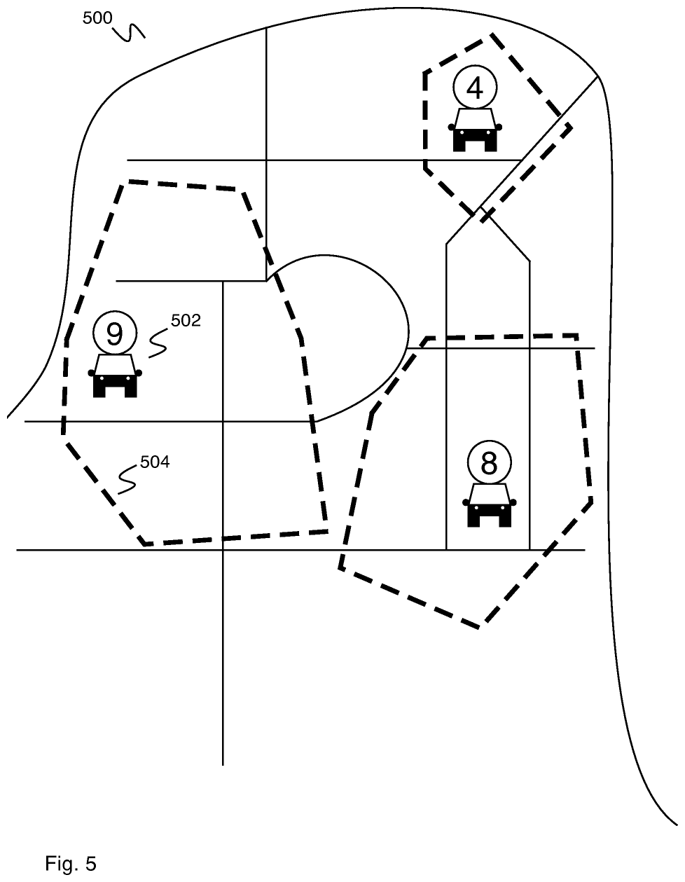

FIG. 5 is a diagram illustrating an embodiment of a city map showing drivers and regions available to them. City map 500 comprises a city map showing city streets and the current location of three drivers for a lift management system without passengers. Associated with each driver is an estimated inefficiency score for the driver (e.g., a time to beat), and a perimeter of driver options (e.g., the area of the city available to the driver to pick up passengers). In the example shown, driver 502 has an associated time to beat of 9 minutes, and a perimeter of driver options shown by perimeter 504. In various embodiments, the perimeter of driver options is determined by partitioning the city among the available drivers, by estimating the distance that can be traveled in the time to beat, by allocating each driver an equal share of expected ride request density (e.g., drivers in high ride request density areas are given a smaller total area), or in any other appropriate way. In some embodiments, the inefficiency score for a driver is determined by computing the minimum of the sum of the driving time to a region and the expected time until a ride request in that region for each region within the perimeter of driver options. In some embodiments, drivers are coached to drive in such a way as to reduce their inefficiency score. In some embodiments, drivers are coached to drive in such a way as to reduce the system inefficiency score. In some embodiments, drivers without passengers receive driving path information from the lift management system to reduce the system inefficiency score.

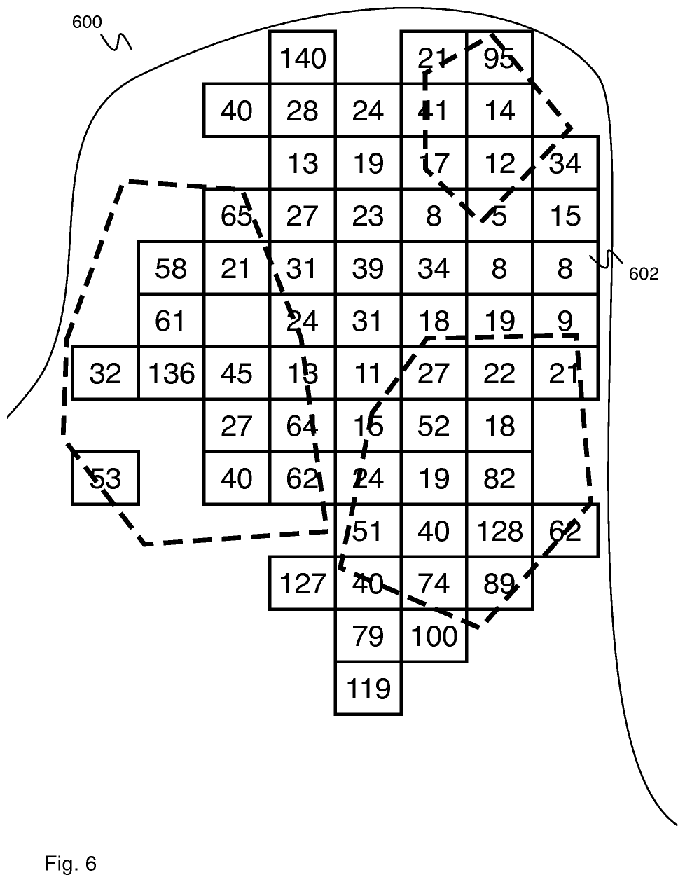

FIG. 6 is a diagram illustrating an embodiment of a city map showing a set of regions and expected ride request wait times. City map 600 comprises a city map showing a set of city regions (e.g., region 602) and associated expected ride request wait times (e.g., 8 minutes). City map 600 additionally shows a set of perimeters of driver options (e.g., the set of perimeters of driving options shown in FIG. 5). In some embodiments, the lift management system divides the city into a set of city regions and determines the expected ride request wait time for each region. In various embodiments, an average city region comprises one square block, a three block by three block region, a 20 square block region, a square mile, or any other appropriate average city region size. In some embodiments, region size varies by city, where cities with more passenger demand tend to have smaller regions. In some embodiments, perimeters of driver options are chosen to include integer numbers of city regions. In some embodiments, associated expected wait times are determined by comparing passenger traffic in and out of a region with historical data. In various embodiments, passenger traffic in and out of a region comprises a measurement of passenger traffic in and out of that region, an aggregate of passenger traffic in and out of nearby regions, an aggregate of passenger traffic in and out of adjacent regions, or any other appropriate passenger traffic measurement. In some embodiments, the passenger traffic in and out of a region is aggregated with passenger traffic in and out of the regions around its perimeter in order to smooth the data set. Patterns of passenger traffic in and out of a region over time are analyzed and compared with historical patterns to identify a historical pattern closely matching the current data. In various embodiments, patterns of passenger traffic in and out of a region over time are compared with historical patterns from the same region, with historical patterns from nearby regions, with historical patterns from similar regions, with historical patterns from all regions, or with any other appropriate set of historical patterns. The matching historical pattern is then used to predict the upcoming demand as time passes. Expected ride request wait times are determined from the predicted upcoming deman. Expected ride request wait times function as exponentially distributed random variables (e.g., ride requests follow a Poisson process of arrivals). In some embodiments, the time to beat for a driver is determined by finding the minimum sum of the estimated driving time to a city region and the expected ride request wait time for that city region over the set of city regions within the available perimeter of driver options.

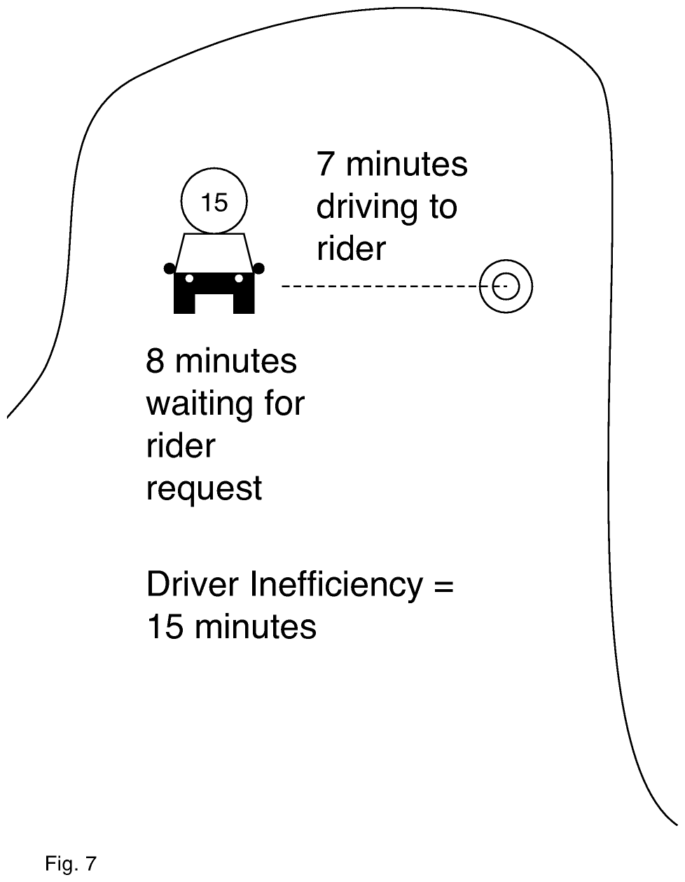

FIG. 7 is a diagram illustrating an embodiment of a driver inefficiency calculation. Driver inefficiency comprises an estimate of the time until the driver next has a passenger (e.g., if a driver was perfectly efficient, he would always have a passenger). In the example shown, the driver inefficiency is calculated to be 15 minutes. The first 8 minutes are spent waiting for a rider request, and the following 7 minutes are spent driving to pick up the rider for that request. The driver can therefore expect to have a rider in 15 minutes. If the driver receives a rider request right now, it will reduce the driver inefficiency to take it if it is less than 15 minutes away, thus the driver inefficiency value is also referred to as the time to beat. When the driver inefficiency calculation is made, it is made for each region available to the driver (e.g., each region available within the perimeters of driver options associated with the driver) and the minimum inefficiency value calculated is determined to be the inefficiency value associated with the driver. The total system inefficiency score is the sum of the driver inefficiency score for each driver without a rider and the travel times for drivers with ride requests who have not yet picked up their riders.

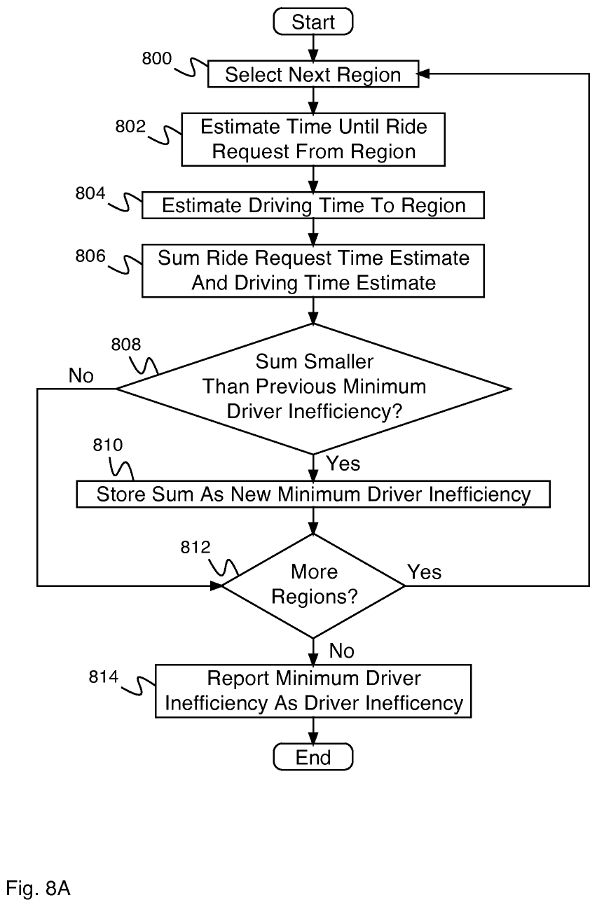

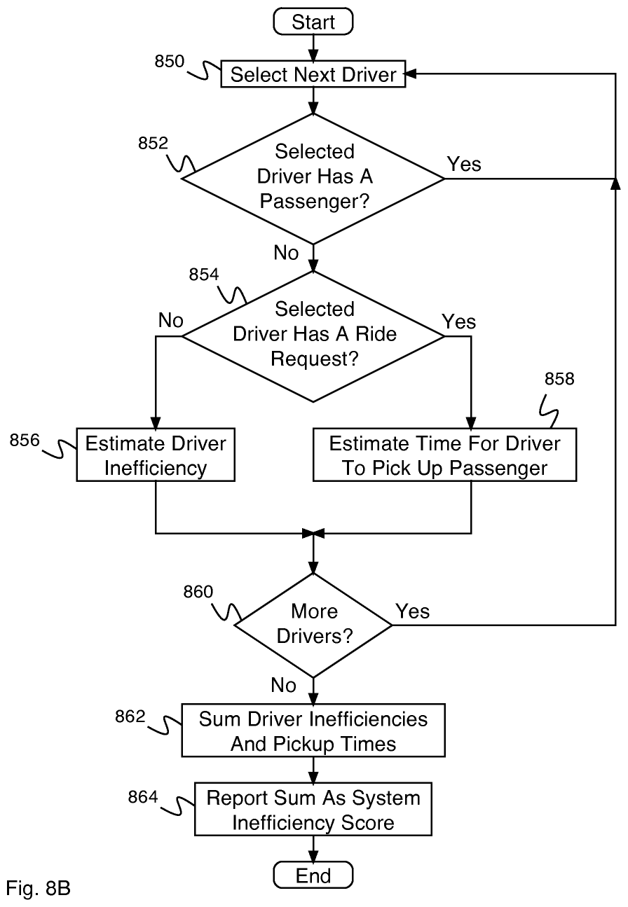

FIG. 8A is a flow diagram illustrating an embodiment of a process for estimating driver inefficiency. In some embodiments, the process of FIG. 8A is used by a lift management system (e.g., lift management system 106 of FIG. 1) for calculating an inefficiency score for a driver (e.g., driver 402 of FIG. 4). In the example shown, in 800, the next region is selected. In some embodiments, a region comprises a city region (e.g., a city region with an expected ride request wait time). In some embodiments, the next region comprises the next region within the perimeter of driver options for the driver. In some embodiments, the next region comprises the first region. In 802, the time until a ride request from the region is received is estimated. In some embodiments, the estimated time until a ride request from the region is received comprises the average time between requests. In some embodiments, the estimated time until a ride request from the region is determined based on a nearest-neighbors machine learning approach that models historical arrivals and departures of ride requests observed in the past. In 804, the driving time to the region is estimated. In some embodiments, a third party driving time estimate (e.g., via Google™ maps, etc.) is used. In some embodiments, historical data is used. In some embodiments, a third party driving time estimate is used until enough historical data is accumulated to be accurate. In some embodiments, simulations are used to determine which driving time estimation source should be used based on minimizing observed error. In 806, the ride request time estimate and the driving time estimate are summed. In 808, it is determined whether the sum is smaller than the previous minimum driver inefficiency. If the sum is determined to not be smaller than the previous minimum driver inefficiency, the sum is discarded and control passes to 812. If the sum is determined to be smaller than the previous minimum driver inefficiency, control passes to 810. In 810, the sum is stored as the new minimum driver inefficiency. In 812, it is determined whether there are more regions (e.g., more regions within the perimeter of driver options for the driver). If it is determined that there are more regions, control passes to 800. If it is determined that there are not more regions, control passes to 814. In 814, the minimum driver inefficiency is reported as the driver inefficiency.

FIG. 8B is a flow diagram illustrating an embodiment of a process for calculating a system inefficiency score. In some embodiments, the process of FIG. 8B is used by a lift management system (e.g., lift management system 106 of FIG. 1) for calculating a system inefficiency score for a set of drivers (e.g., a set of drivers as shown in FIG. 4). In various embodiments, the set of drivers comprises all drivers in the lift management system, all drivers without passengers in the lift management system, all drivers without passengers and drivers about to be without passengers in the lift management system, all nearby drivers in the lift management system, or any other appropriate set of drivers in the lift management system. In various embodiments, the set of drivers about to be without passengers is determined based on the estimated time until each driver does not have a passenger, is determined based on the proximity to the destination of each driver, is determined based on the distance each driver has driven, or is determined in any other appropriate way.

In the example shown, in 850, the next driver is selected. In some embodiments, the next driver comprises the first driver. In 852, it is determined whether the selected driver has a passenger. If it is determined that the selected driver has a passenger, they do not contribute to the system inefficiency score, and control passes to 850. If it is determined that the selected driver does not have a passenger, control passes to 854. In 854, it is determined whether the selected driver has a ride request. If it is determined that the selected driver has a ride request, inefficiency is determined directly by estimating driving time, and control passes to 858. In 858, the time for the driver to pick up the passenger is estimated. Control then passes to 860. If it is determined in 854 that the selected driver does not have a ride request, control passes to 856. In 856, the driver inefficiency is estimated. In some embodiments, the driver inefficiency is estimated using the process of FIG. 8A. Control then passes to 860. In 860, it is determined whether there are more drivers. If it is determined that there are more drivers, control passes to 850. If it is determined that there are not more drivers, control passes to 862. In 862, the driver inefficiencies (e.g., the driver inefficiencies estimated in 856) and pickup times (e.g., the pickup times estimated in 858) are summed. In 864, the sum is reported as the system inefficiency score.

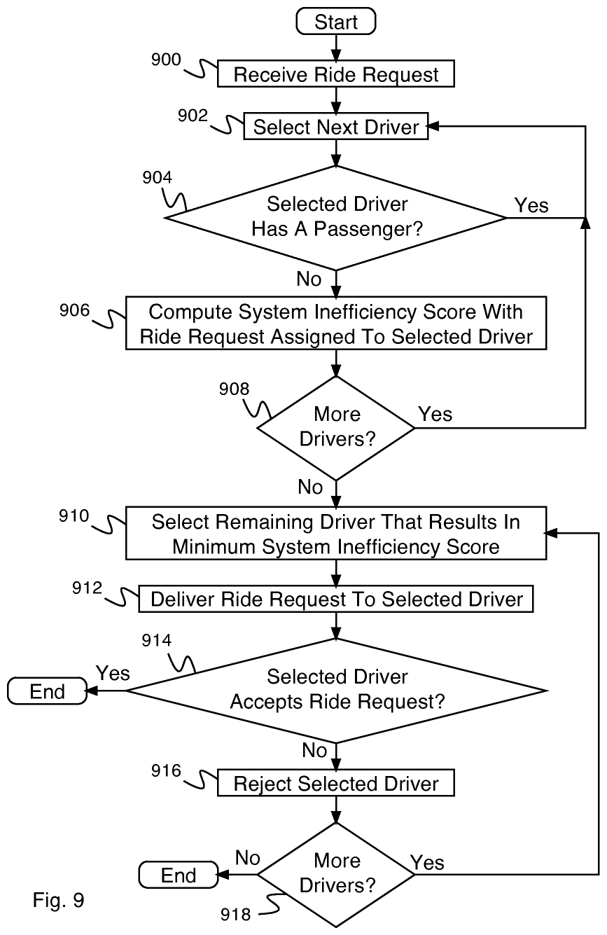

FIG. 9 is a flow diagram illustrating an embodiment of a process for dispatching a driver. In some embodiments, the process of FIG. 9 is used by a lift management system (e.g., lift management system 106 of FIG. 1) for dispatching a ride request to a set of drivers in an order determined to minimize system inefficiency. In the example shown, in 900, a ride request is received. In 902, the next driver (e.g., the next driver for the lift management system) is selected. In some embodiments, the next driver comprises the first driver. In 904, it is determined whether the next driver has a passenger. If it is determined that the next driver has a passenger, the driver is ignored for the remainder of the process, and control passes to 902. If it is determined that the selected driver does not have a passenger, control passes to 906. In 906, the system inefficiency score is computed with the ride request assigned to the selected driver. In some embodiments, the system inefficiency score is computed using the process of FIG. 8B. In some embodiments, computing the system inefficiency score with the ride request assigned to the selected driver comprises removing the selected driver from the list of available drivers, computing the inefficiency for each of the remaining drivers, and adding the time for the driver to get to the ride request. In some embodiments, removing the selected driver from the list of available drivers can change the perimeters of driver options for the other drivers and thus change their inefficiency. In 908, it is determined whether there are more drivers. If it is determined that there are more drivers, control passes to 902. If it is determined that there are not more drivers, control passes to 910. In 910, the remaining driver that results in the minimum system inefficiency score is selected (e.g., the driver for which the minimum associated system inefficiency score computed in 906 is selected). In some embodiments, the first driver for which the system inefficiency score is reduced by an amount greater than a threshold is selected. In some embodiments, in the event that a previous ride comprising the rider and the selected driver resulted in an unsatisfactory rating, the selected driver is rejected and a next driver is selected to take the ride request. In some embodiments, an unsatisfactory rating comprises a rider giving a driver an unsatisfactory rating. In some embodiments, an unsatisfactory rating comprises a driver giving a rider an unsatisfactory rating. In 912, the ride request is delivered to the selected driver. In 914, it is determined whether the selected driver accepts the ride request. If it is determined that the selected driver accepts the ride request, the process ends. If it is determined that the selected driver does not accept the ride request, control passes to 916. In 916, the selected driver is rejected (e.g., removed from further consideration). In 918, it is determined whether there are more drivers. If it is determined that there are more drivers, control passes to 910. If it is determined that there are not more drivers, the process ends.

In some embodiments, in addition to determining the driver to dispatch to reduce the system inefficiency score, the lift management system determines a driving path for a driver without a passenger to reduce the system inefficiency score. The drivers can be positioned in the ideal way to handle the expected demand. In some embodiments, the driving path is computed by looking at all possible locations that all available drivers could travel, minute by minute, and computing the system inefficiency score for each combination of resulting driver positions. In some embodiments, the algorithm assumes the resulting positioning that minimized the system inefficiency score is optimal. In some embodiments, the algorithm proceeds for each driver until the maximum expected time until request is reached.

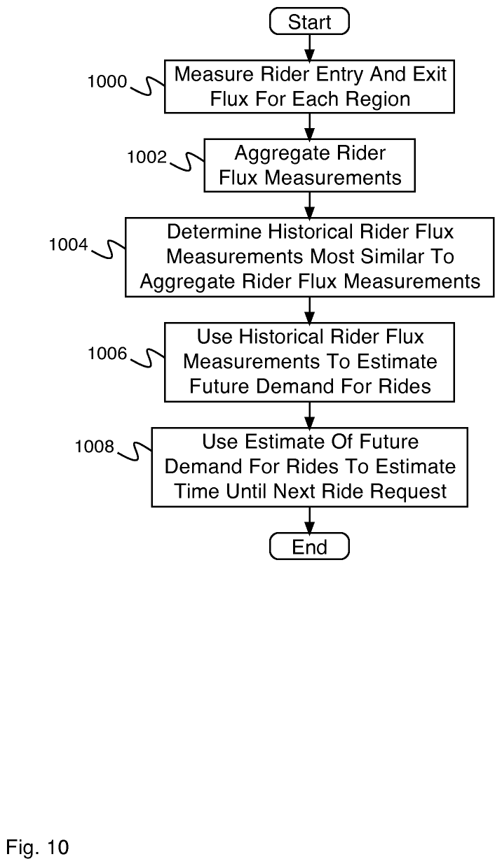

FIG. 10 is a flow diagram illustrating an embodiment of a process for determining an estimate of a time until a ride request. In some embodiments, the process of FIG. 10 is used by a lift management system (e.g., lift management system 106 of FIG. 1) for determining an estimate of a time until a ride request. In the example shown, in 1000, rider entry and exit flux is measured for each region (e.g., each region of the map of FIG. 6). In some embodiments, rider entry flux is measured by counting the number of riders arriving in the region. In some embodiments, rider exit flux is measured by counting the number of riders departing from the region. In 1002, rider flux measurements are aggregated. In various embodiments, rider flux measurements are combined with rider flux measurements from nearby regions, from adjacent regions, from similar regions, or from any other appropriate regions. In some embodiments, a different aggregate rider flux measurement is computed for each region. In 1004, the historical rider flux measurements most similar to the aggregate rider flux measurements are determined. In various embodiments, the aggregate rider flux measurements are compared with historical rider flux measurements from the same region, with historical rider flux measurements from nearby regions, with historical rider flux measurements from similar regions, with historical rider flux measurements from all regions, or with any other appropriate set of historical rider flux measurements. In 1006, the historical rider flux measurements are used to estimate the future demand for rides. In 1008, the estimate of the future demand for rides is used to estimate the time until the next ride request.

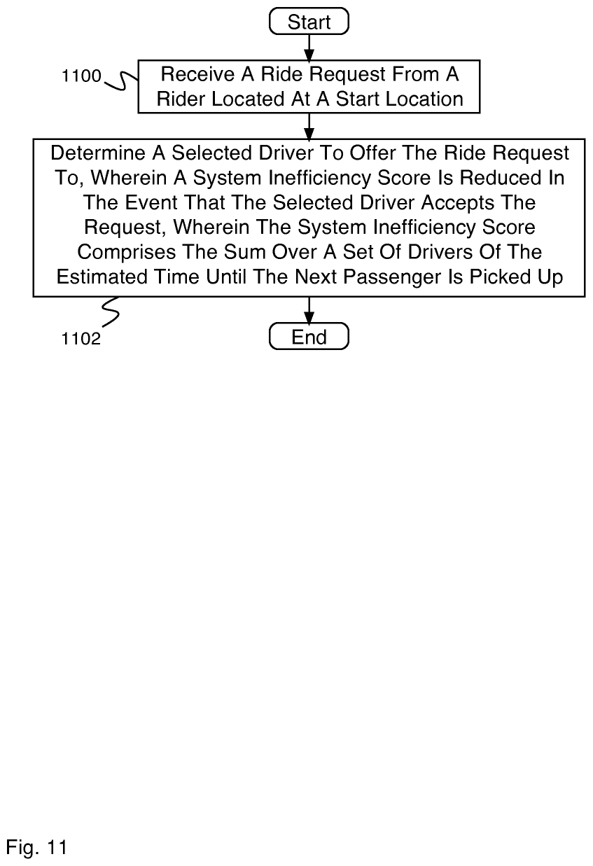

FIG. 11 is a flow diagram illustrating an embodiment of a process for dispatching a driver. In some embodiments, the process of FIG. 11 is used by a lift management system (e.g., lift management system 106 of FIG. 1) for dispatching a driver. In the example shown, in 1100, a ride request is received from a rider located at a start location. In 1102, a selected driver is determined to take the ride request, wherein a system inefficiency is reduced in the event that the selected driver accepts the request, wherein the system inefficiency score comprises the sum over a set of drivers of the estimated time until the next passenger is picked up.

Although the foregoing embodiments have been described in some detail for purposes of clarity of understanding, the invention is not limited to the details provided. There are many alternative ways of implementing the invention. The disclosed embodiments are illustrative and not restrictive.

1-21. (canceled)

22. A system, comprising:
at least one server computer comprising at least one non-transitory computer readable storage medium storing instructions that, when executed by the at least one server computer, cause the system to:
determine, based on global positioning systems of a set of driver computing devices, driver option perimeters corresponding to locations for the set of driver computing devices;
utilize a machine learning model to process historical traffic patterns and current traffic patterns to predict ride request wait times for a set of regions within the driver option perimeters;
process the predicted ride request wait times and driving times between the locations and the set of regions to determine minimum driver inefficiencies comprising times to beat for the set of driver computing devices; and
in response to receiving a digital transportation request comprising a pick-up location from a rider computing device, compare the times to beat and a set of driving times between the locations and the pick-up location to generate an ordered ranking of the set of driver computing devices for transmitting the digital transportation request.

23. The system of claim 22, further comprising instructions that, when executed by the at least one server computer, cause the system to determine the driver option perimeters by dividing a geographical region based on ride request densities within the geographical region and driver computing devices in the set of driver computing devices.

24. The system of claim 22, further comprising instructions that, when executed by the at least one server computer, cause the system to utilize the machine learning model by modeling the historical traffic patterns utilizing a nearest-neighbors machine learning model.

25. The system of claim 22, further comprising instructions that, when executed by the at least one server computer, cause the system to modify the driver option perimeters based on the times to beat.

26. The system of claim 22, further comprising instructions that, when executed by the at least one server computer, cause the system to determine a time to beat for a driver computing device by:
determining combined times for the set of regions by combining the ride request wait times for the set of regions and determined driving times between a location of the driver computing device and the set of regions; and
identifying the time to beat by comparing combined times for the set of regions.

27. The system of claim 22, further comprising instructions that, when executed by the at least one server computer, cause the system to:
select a driver computing device from the set of driver computing devices based on the ordered ranking; and
transmit the digital transportation request to the driver computing device together with navigation instructions such that the driver computing device navigates to the pick-up location.

28. The system of claim 22, further comprising instructions that, when executed by the at least one server computer, cause the system to generate the ordered ranking by arranging the driver computing devices in an order that maximizes system efficiency across the driver computing devices.

29. A computer-implemented method, comprising:
determining, based on global positioning systems of a set of driver computing devices, driver option perimeters corresponding to locations for the set of driver computing devices;
utilizing a machine learning model to process historical traffic patterns and current traffic patterns to predict ride request wait times for a set of regions within the driver option perimeters;
processing the predicted ride request wait times and driving times between the locations and the set of regions to determine minimum driver inefficiencies comprising times to beat for the set of driver computing devices; and
in response to receiving a digital transportation request comprising a pick-up location from a rider computing device, comparing the times to beat and a set of driving times between the locations and the pick-up location to generate an ordered ranking of the set of driver computing devices for transmitting the digital transportation request.

30. The computer-implemented method of claim 29, further comprising determining the driver option perimeters by dividing a geographical region based on ride request densities within the geographical region and driver computing devices in the set of driver computing devices.

31. The computer-implemented method of claim 29, wherein utilizing the machine learning model comprises modeling the historical traffic patterns utilizing a nearest-neighbors machine learning model.

32. The computer-implemented method of claim 29, further comprising modifying the driver option perimeters based on the times to beat.

33. The computer-implemented method of claim 29, further comprising determining a time to beat for a driver computing device by:
determining combined times for the set of regions by combining the ride request wait times for the set of regions and determined driving times between a location of the driver computing device and the set of regions; and
identifying the time to beat by comparing combined times for the set of regions.

34. The computer-implemented method of claim 29, further comprising:
selecting a driver computing device from the set of driver computing devices based on the ordered ranking; and
transmitting the digital transportation request to the driver computing device together with navigation instructions such that the driver computing device navigates to the pick-up location.

35. The computer-implemented method of claim 29, further comprising generating the ordered ranking by arranging the driver computing devices in an order that maximizes system efficiency across the driver computing devices.

36. A non-transitory computer readable medium storing instructions thereon that, when executed by at least one processor, cause a computer system to:
determine, based on global positioning systems of a set of driver computing devices, driver option perimeters corresponding to locations for the set of driver computing devices;
utilize a machine learning model to process historical traffic patterns and current traffic patterns to predict ride request wait times for a set of regions within the driver option perimeters;
process the predicted ride request wait times and driving times between the locations and the set of regions to determine minimum driver inefficiencies comprising times to beat for the set of driver computing devices; and
in response to receiving a digital transportation request comprising a pick-up location from a rider computing device, compare the times to beat and a set of driving times between the locations and the pick-up location to generate an ordered ranking of the set of driver computing devices for transmitting the digital transportation request.

37. The non-transitory computer readable medium of claim 36, further comprising instructions that, when executed by the at least one processor, cause the computer system to determine the driver option perimeters by dividing a geographical region based on ride request densities within the geographical region and driver computing devices in the set of driver computing devices.

38. The non-transitory computer readable medium of claim 36, further comprising instructions that, when executed by the at least one processor, cause the computer system to utilize the machine learning model by modeling the historical traffic patterns utilizing a nearest-neighbors machine learning model.

39. The non-transitory computer readable medium of claim 36, further comprising instructions that, when executed by the at least one processor, cause the computer system to determine a time to beat for a driver computing device by:
determining combined times for the set of regions by combining the ride request wait times for the set of regions and determined driving times between a location of the driver computing device and the set of regions; and
identifying the time to beat by comparing combined times for the set of regions.

40. The non-transitory computer readable medium of claim 36, further comprising instructions that, when executed by the at least one processor, cause the computer system to:
select a driver computing device from the set of driver computing devices based on the ordered ranking; and
transmit the digital transportation request to the driver computing device together with navigation instructions such that the driver computing device navigates to the pick-up location.

41. The non-transitory computer readable medium of claim 36, further comprising instructions that, when executed by the at least one processor, cause the computer system to generate the ordered ranking by arranging the driver computing devices in an order that maximizes system efficiency across the driver computing devices.
